(19) United States
(12) Patent Application Publication
(10) Pub. No.: US 2010/0321821 A1
(43) Pub. Date: Dec. 23, 2010

(54) DISK DEVICE AND ASPIRATION FILTER USED THEREFOR

(75) Inventor: Takayuki IWASE, Higashiyamato-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/817,072

(22) Filed: Jun. 16, 2010

(30) Foreign Application Priority Data
Jun. 23, 2009 (JP) 2009-148875

(51) Int. Cl. G11B 33/14

(52) U.S. Cl. 360/97.02; G9B/33.035

(57) ABSTRACT

According to an embodiment, a disk device includes a housing configured to contain therein a disk-shaped recording medium, a drive section configured to rotate the recording medium, a head configured to subject the recording medium to information processing, and an aspiration filter arranged inside the housing, including a casing including an inner side portion facing the recording medium, and an outer side portion positioned on the opposite side of the recording medium with respect to the inner side portion, and containing therein adsorbent configured to adsorb a substance in air, an inlet port in the casing and configured to take outside air into the casing, and an exhaust port in the outer side portion and configured to discharge the outside air that has passed through the adsorbent to the inside of the disk device.

### CROSS-REFERENCE TO RELATED APPLICATIONS

This application is based upon and claims the benefit of priority from Japanese Patent Application No. 2009-148875, filed Jun. 23, 2009; the entire contents of which are incorporated herein by reference.

### FIELD

Embodiments described herein relate generally to a disk device, and a filter used for the disk device.

### BACKGROUND

In recent years, a disk device such as a magnetic disk device, optical disk device, and the like is widely used as an external recording device or image recording device of a computer.

In general, a magnetic disk device, for example, a hard disk drive (HDD) is provided with a magnetic disk, spindle motor configured to rotate the magnetic disk, magnetic head configured to read/write data from/to the magnetic disk, carriage assembly supporting the magnetic head thereon, voice coil motor configured to drive the carriage assembly, substrate unit, and the like, and these members are contained in a housing of a substantially sealed structure. The HDD is provided with an aspiration filter configured to remove dust, moisture, and gas components of outside air flowing from a vent hole formed in the housing.

In the HDD, an aspiration filter of a casing type in which much of adsorbent such as activated charcoal or the like can be contained is widely used as a flow path through which the outside and inside of the housing communicate with each other. In the case of a structure in which an aspiration hole is provided in the base or top cover of the housing, and an aspiration filter is affixed over the aspiration hole, in the casing, an exhaust port is provided on the opposite side of the aspiration hole, and air entering the casing from the aspiration hole is filtered by the activated charcoal or the like, and thereafter flows into the inside of the housing from the exhaust port (for example, Jpn. Pat. Appln. KOKAI Publication No. 09-147544).

In the HDD configured as described above, regarding the air that has entered the inside from the outside of the housing through the aspiration filter, there is the possibility of the contaminant such as external dust and mote that have not been completely removed being contained in the air. Further, when a strong impact is applied to the aspiration filter, the possibility of the activated charcoal or the like sealed as the adsorbent of the aspiration filter entering the inside of the housing through the membrane or the like affixed over the exhaust port is conceivable. In these cases, there is the strong possibility of the contaminant existing in the vicinity of the exhaust port of the aspiration filter.

In the magnetic disk device, the flow of air generated when the disk is rotated becomes a flow from the center of the disk toward the outer circumferential side near the surface of the disk, whereas on the surface separate from the disk, i.e., near the base, or the top cover, the flow of air becomes a flow from the outer circumferential side of the disk toward the center thereof. In the casing type aspiration filter, when the filter is configured, as described above, in such a manner that the exhaust port is on the opposite side of the aspiration hole, and the height of the filter is made sufficiently large so that much of adsorbent can be contained in the filter, the exhaust port of the filter inevitably becomes close to the base on the opposite side of the surface on which the casing is stuck or the surface of the top cover. As a result of this, air involving a risk of containing the contaminant that has entered the inside from the outside of the housing through the aspiration filter, or powder of the adsorbent of the filter is introduced into the flow toward the disk center side. This flow gets close to the disk at the center of the disk, and thereafter becomes a flow along the surface of the disk toward the outer circumferential side. Accordingly, that the contaminant and the like are contained in the flow implies the risk of damaging the disk surface and magnetic head, this being a factor in the degradation of the reliability of the magnetic disk device.

### BRIEF DESCRIPTION OF THE DRAWINGS

FIG. 1 is an exemplary plan view showing an HDD according to an embodiment with a top cover thereof removed;

FIG. 2 is an exemplary perspective view showing a magnetic disk and aspiration filter of the HDD;

FIG. 3 is an exemplary perspective view showing the aspiration filter in an enlarging manner;

FIG. 4 is an exemplary cross-sectional view of the HDD along line IV-IV in FIG. 2, showing a relationship between the flow of air on the magnetic disk, and aspiration filter;

FIG. 5 is an exemplary cross-sectional view showing the aspiration filter in an enlarging manner;

FIG. 6 is an exemplary cross-sectional view of an aspiration filter according to a second embodiment; and

FIG. 7 is an exemplary perspective view showing a manufacturing process of the aspiration filter according to the second embodiment.

### DETAILED DESCRIPTION

In general, according to one embodiment, a disk device comprises: a housing configured to contain therein a disk-shaped recording medium; a drive section configured to rotate the recording medium; a head configured to subject the recording medium to information processing; and an aspiration filter arranged inside the housing. The aspiration filter comprises a casing including an inner side portion facing the recording medium, and an outer side portion positioned on the opposite side of the recording medium with respect to the inner side portion, and containing therein adsorbent configured to adsorb a substance in air, an inlet port in the casing and configured to take outside air into the casing, and an exhaust port in the outer side portion and configured to discharge the outside air that has passed through the adsorbent to the inside of the disk device.

HDDs according to embodiments will be described in detail with reference to the drawings.

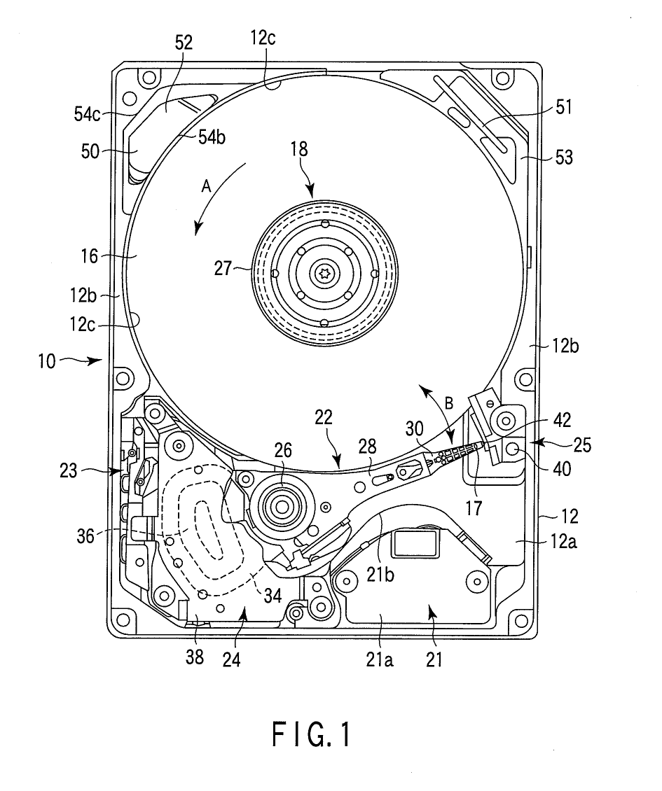

FIG. 1 shows the internal structure of an HDD according to a first embodiment by removing a top cover thereof. As shown in FIG. 1, the HDD comprises a housing 10. The housing 10 includes a rectangular box-shaped base 12 opened at the top surface, and top cover 11 to be described later configured to close the upper end opening of the base by being screwed to the base by a plurality of screws. The base 12 includes a rectangular bottom wall 12a, and sidewall 12b provided to stand along the peripheral edge of the bottom wall.

A spindle motor 18 attached to the bottom wall 12a of the base 12, and magnetic disk 16 supported and rotated by the spindle motor are arranged inside the housing 10. In the housing 10 are arranged a plurality of magnetic heads 17 configured to record/reproduce information on/from the magnetic disk 16, carriage assembly 22 configured to support the magnetic heads movable with respect to the magnetic disk 16, voice coil motor (VCM) 24 configured to carry out rotation and positioning of the carriage assembly, ramp load mechanism 25 configured, when the magnetic head moves to the outermost circumference of the magnetic disk, to retain the magnetic head at a retracted position separate from the magnetic disk, inertia latch mechanism 23 configured, when an impact or the like is applied to the HDD, to retain the carriage assembly at the retracted position, and board unit 21 including a preamplifier, and the like are contained. A printed circuit board (not shown) is screwed to the outer surface of the bottom wall 12a of the base 12. The printed circuit board controls operations of the spindle motor 18, VCM 24, and magnetic head through the board unit 21.

The magnetic disk 16 as a recording medium is formed into a size of, for example, a diameter of 65 mm (2.5 inch), and includes a magnetic recording layer on each of a top surface and undersurface. The magnetic disk 16 is concentrically fitted onto a hub (not shown) of the spindle motor 18, and is clamped by a clamping spring 27 to be fixed to the hub. As a result of this, the magnetic disk 16 is supported in a state where the disk 16 is positioned parallel to the bottom wall 12a of the base 12, and top cover. Further, the magnetic disk 16 is rotated by the spindle motor 18 functioning as a drive section at a predetermined speed of, for example, 5400 rpm or 7200 rpm in the arrow A direction.

Among the parts of the sidewall 12b, the part of the sidewall 12b positioned at a substantially midway area of the base 12 in the longitudinal direction is positioned to surround the outer circumference of the magnetic disk 16. An inner surface 12c of the part of the sidewall 12b is formed into an arcuate shape along the outer circumference of the magnetic disk 16, and is opposed to the outer circumference of the magnetic disk with a small gap held between them.

The carriage assembly 22 comprises a bearing section 26 fixed on the bottom wall 12a of the base 12, and two arms 28 extending from the bearing section. The bearing section 26 is positioned separate from the rotation center of the magnetic disk in the longitudinal direction of the base 12, and is positioned in the vicinity of the outer circumference of the magnetic disk. The two arms 28 are positioned parallel to the surface of the magnetic disk 16 with a predetermined gap held between them, and extend from the bearing section 26 in the same direction. The carriage assembly 22 is provided with an elastically deformable long and thin plate-shaped suspension 30. The suspension 30 is attached to a distal end of the arm 28 at a proximal end thereof by spot welding or adhesion, and extends from the arm. It should be noted that each suspension 30 may be formed integral with the corresponding arm 28.

A magnetic head 17 is attached to an extension end of the suspension. The magnetic head 17 includes a substantially rectangular slider, and a magnetoresistive (MR) head for recording/reproduction formed on the slider, and is fixed to a gimbal section formed at a distal end part of the suspension 30. The two magnetic heads 17 each attached to the suspensions 30 are positioned in opposition to each other, and are arranged in such a manner that the magnetic disk 16 is interposed between the magnetic heads 17.

On the other hand, the carriage assembly 22 includes a support frame 34 extending from the bearing section 26 in the direction opposite to the arm 28, and a voice coil 36 constituting part of the VCM 24 is supported by the support frame. The support frame 34 is formed integral with the outer circumference of the voice coil 36 by using a synthetic resin. The voice coil 36 is positioned between a pair of yokes 38 fixed on the base 12, and constitutes the VCM 24 together with the yokes, and a magnet (not shown) fixed to one of the yokes. By energizing the voice coil 36, the carriage assembly 22 is rotated around the bearing section 26 in the arrow B directions, and the magnetic head 17 is moved to, and positioned at a desired track of the magnetic disk 16. As a result of this, the magnetic head 17 can write or read information to or from the magnetic disk 16. The carriage assembly 22 and VCM 24 constitute a head actuator.

The ramp load mechanism 25 is provided with a ramp 40 provided on the bottom wall 12a of the base 12, and arranged outside the magnetic disk 16, and tabs 42 extending from the distal ends of the suspensions 30. The ramp 40 is positioned on the downstream side of the bearing section 26 with respect to the direction of rotation A of the magnetic disk 16. When the carriage assembly 22 is rotated, and the magnetic head 32 is rotated to the retracted position outside the magnetic disk 16a or 16b, each of the tabs 42 is engaged with a ramp surface formed on the ramp 40, and is thereafter raised by the inclination of the ramp surface, whereby the magnetic head 32 is unloaded.

The board unit 21 includes a main body 21a constituted of a flexible printed circuit board, and the main body 21a is fixed to the bottom wall 12a of the base 12. Electronic components such as a head amplifier and the like are mounted on the main body 21a. The board unit 21 includes a main flexible printed circuit board (main FPC) 21b extending from the main body 21a. An extension end of the main FPC 21b is connected to the vicinity of the bearing section 26 of the carriage assembly 22, and is further electrically connected to the magnetic head 17 through a cable (not shown) provided on the arm 28 and suspension 30. A connector (not shown) for connection to the printed circuit board is mounted on the bottom surface of the main body of the board unit 21.

The HDD comprises an aspiration filter 50 configured to capture and remove the substances contained in the outside air flowing from the aspiration hole formed in the top cover or the bottom wall 12a of the base 12, for example, the contaminant such as dust, moisture, gas components, and the like, and circulation filter 51 configured to capture dust generated inside the housing by the operations of the movable parts. These aspiration filter 50 and circulation filter 51 are arranged around the magnetic disk 16.

More specifically, the circulation filter 51 is formed into, for example, a rectangular mat-shape, and is provided at one of the corner parts of the base 12 on the downstream side of the magnetic head 17 or the ramp 40 with respect to the direction of rotation A of the magnetic disk 16, and closest to the magnetic head 17 or the ramp 40. The base 12 includes a guide flow path 53 configured to guide the airstream to the circulation filter 51 formed on the sidewall 12b. By the high-speed rotation of the magnetic disk 16, an airstream in the direction of rotation of the magnetic disk is generated. Part of the airstream flows into the guide flow path 53, passes through the circulation filter 51, and the dust contained in the airstream is captured by the circulation filter 51. Thereafter, the airstream is returned toward the magnetic disk 16, and is caused to join the airstream flowing along the outer circumference of the magnetic disk.

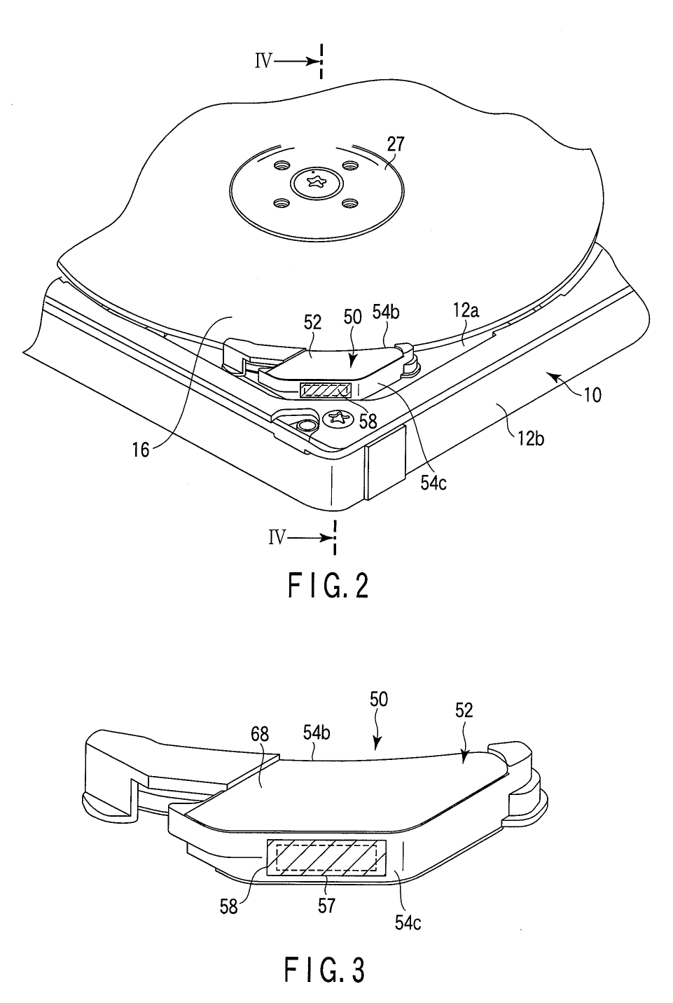

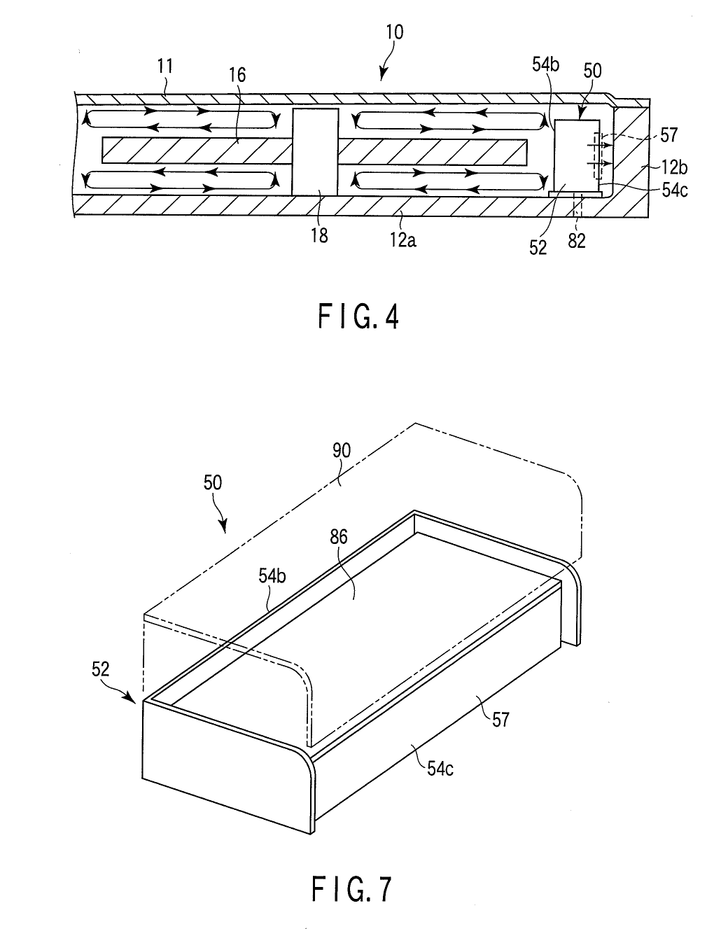

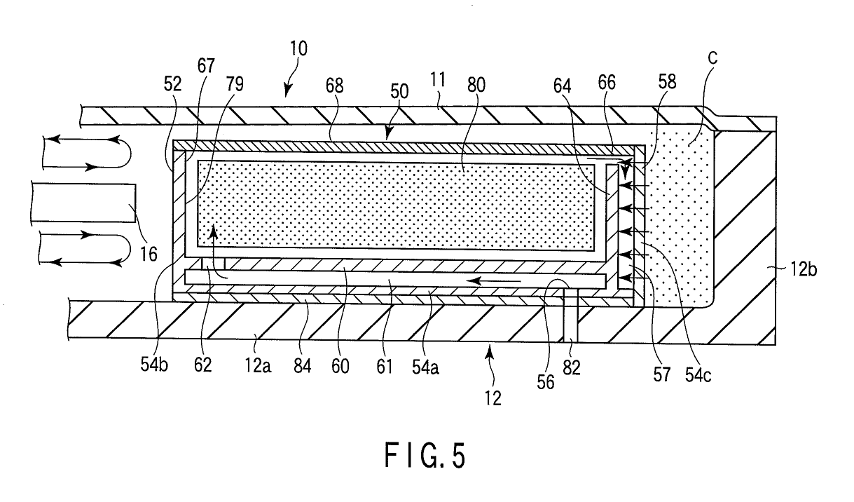

The aspiration filter 50 is provided at one of the corner parts of the base 12 on the downstream side of the circulation filter 51 with respect to the direction of rotation A of the magnetic disk 16, and closest to the circulation filter. FIG. 2 is a perspective view showing the arrangement relationship between the aspiration filter and magnetic disk 16, FIG. 3 is a perspective view showing the aspiration filter in an enlarging manner, FIG. 4 is a cross-sectional view of the HDD showing the arrangement relationship between the aspiration filter and magnetic disk 16, and FIG. 5 is a cross-sectional view showing the aspiration filter in an enlarging manner.

As shown in FIGS. 2, 3 and 5, the aspiration filter 50 is provided with a long and thin substantially rectangular or arcuate casing 52 formed of a synthetic resin or the like. The casing 52 includes a substantially flat top wall, bottom wall 54a, substantially arcuate inner side wall 54b formed along the outer circumferential shape of the magnetic disk 16, and outer side wall 54c positioned on the opposite side of the inner side wall. The outer side wall 54c is formed into a substantially trapezoidal shape in accordance with the shape of the corner part of the sidewall 12b of the housing 10. An inlet port 56 is formed in the bottom wall 54a of the casing 52, and exhaust port 57 is formed in the outer side wall 54c. The exhaust port 57 is covered with a cover film 58 such as a membrane or the like having air permeability. Inside the casing 52, a lower partition wall 60 is formed parallel to the bottom wall 54a with a gap held between them, and airway 61 is formed between the bottom wall and lower partition wall 60. Further, a vent hole 62 is formed in the lower partition wall 60 at a position separate from the exhaust port 57. The airway 61 communicates with the inlet port 56 and vent hole 62.

An exhaust side partition wall is provided in the casing 52 in a standing manner, and the exhaust side partition wall is opposed to the exhaust port 57 with a gap held between them. An upper end of the exhaust side partition wall 64 is positioned with a gap held between the wall 64 and top wall of the casing 52, thereby forming an airway 66 between the wall 64 and top wall.

A relatively large top opening 67 is formed in the top wall of the casing 52, and at the time of assembly, adsorbent 80 such as activated charcoal or the like is filled into the casing 52 from the top opening 67. After filling of the adsorbent 80, the top opening 67 is closed with a cover film 68 having no air permeability such as PET.

The aspiration filter 50 configured as described above is provided to cover the aspiration hole 82 formed in the housing 10 as shown in FIGS. 1, 2, 4 and 5. In this embodiment, the aspiration hole 82 is formed in the bottom wall 12a of the base 12 in a penetrating manner, and it is possible to breathe the outside air into the housing 10 through the aspiration hole 82. The aspiration hole 82 is formed at the corner part of the housing 10. The bottom surface of the casing 52 is affixed to the bottom wall 12a of the base 12 by means of an adhesive layer 84 so that the aspiration filter 50 can cover the aspiration hole 82. At this time, the casing 52 is arranged in such a manner that the inlet port 56 of the bottom wall 54a is positioned in line with the aspiration hole 82 to communicate with the aspiration hole 82.

Further, the casing 52 is arranged in a state where the inner side wall 54b is opposed to the outer circumference of the magnetic disk 16 with a small gap held between them, and outer side wall 54c is positioned on the opposite side of the magnetic disk 16. As a result of this, the exhaust port 57 formed in the outer side wall 54c is positioned on the opposite side of the magnetic disk 16, and is positioned separate from the magnetic disk. Further, the top wall of the casing 52 is opposed to the top cover 11 with a gap held between them.

According to the HDD configured as described above, when the magnetic disk 16 is driven by the spindle motor 18, and is rotated at a high speed, a flow of air from the inner circumferential side of the magnetic disk 16 toward the outer circumferential side along the surface of the magnetic disk 16 is generated as shown in FIGS. 4 and 5. As a result of this, the atmospheric pressure is lowered at the central part of the magnetic disk, and consequently, a flow of air into the central part of the magnetic disk along the top cover 11 or base 12 is generated. Accordingly, in the vicinity of each of the top cover 11 and bottom wall 12a of the base 12, a flow of air from the outer circumferential side of the magnetic disk 16 toward the central part of the magnetic disk 16 exists and, if contaminant or the like is mixed in this flow, there is the strong possibility of the contaminant being transferred to the surface of the magnetic disk, thereby degrading the reliability of the magnetic disk.

In the aspiration filter 50, the outside air flowing into the aspiration filter 50 from the aspiration hole 82 through the inlet port 56 flows through the airway 61, and flows into a reception chamber 79 of the casing 52 from the vent hole 62 as shown in FIG. 5. Further, the outside air passes through the adsorbent 80 such as the activated charcoal or the like contained in the reception chamber 79. At this time, the contaminant such as dust, moisture, gas components, and the like contained in the outside air is removed by the adsorbent 80. The outside air from which the contaminant has been removed passes through the airway 66, goes to the exhaust port 57, and is then discharged to the inside of the housing 10 through the cover film 58. As described above, the lower partition wall 60, vent hole 62, exhaust side partition wall 64, and airway 66 are provided in the casing 52, and hence the outside air flowing into the casing 52 from the inlet port 56 is discharged from the exhaust port 57 after being sufficiently brought into contact with the adsorbent 80 such as the activated charcoal or the like without directly flowing into the exhaust port 57. As a result of this, it is possible to efficiently remove the contaminant in the outside air, and cause the aspiration filter 50 to effectively exert the function thereof.

Further, the exhaust port 57 of the casing 52 is provided in the outer side wall 54c positioned on the opposite side of the magnetic disk 16, and is positioned on the opposite side of the magnetic disk 16 separate from the magnetic disk. That is, the exhaust port 57 is provided at a position separate from an area in which the flow of air toward the center side of the magnetic disk 16 is generated. Accordingly, even when contaminant mixed with the outside air without being removed by the aspiration filter 50, or a fragment of the adsorbent is discharged to the inside of the housing 10 through the exhaust port 57, the contaminant, fragment or the like is not directly transferred onto the magnetic disk 16 by the flow of air toward the center side of the magnetic disk 16. As shown in FIG. 5, the contaminant, fragment or the like stagnantly remains in the space between the aspiration filter 50 and sidewall 12b of the base 12, and is prevented from being transferred onto the surface of the magnetic disk 16.

From the above description, it is possible to obtain a high-reliability aspiration filter configured to reduce the risk of the air entering the magnetic disk device from outside through the aspiration filter being directly transferred onto the magnetic disk 16, and disk device provided with the aspiration filter.

It should be noted that although the first embodiment is configured in such a manner that the aspiration hole 82 is provided in the base 12, and aspiration filter 50 is provided on the bottom wall of the base, the configuration is not limited to this, and the configuration in which the aspiration hole is formed in the top cover, and aspiration filter is arranged on the inner surface of the top cover may also be employed. In this case too, the exhaust port 57 of the casing 52 is provided on the opposite side of the magnetic disk 16. Further, the position of the aspiration filter 50 is not limited to the corner part in the housing 10, and the filter 50 may also be provided at the other position.

Next, an aspiration filter according to a second embodiment will be described.

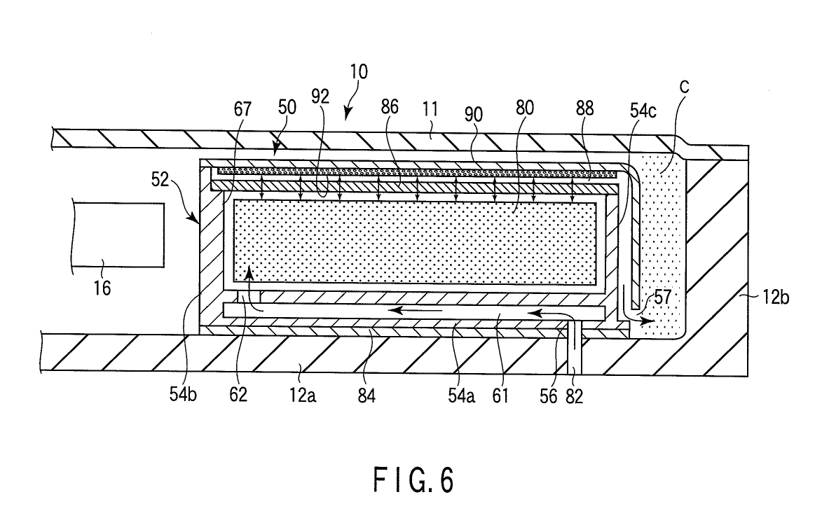

FIG. 6 is a cross-sectional view of a part of an HDD at which the aspiration filter according to the second embodiment is arranged, and FIG. 7 is a perspective view showing the aspiration filter by partially disassembling the filter.

As shown in FIGS. 6 and 7, the aspiration filter 50 is provided with a long and thin substantially rectangular or arcuate casing 52 formed of a synthetic resin or the like. The casing 52 includes a substantially flat top wall, bottom wall 54a, substantially arcuate inner side wall 54b formed along the outer circumferential shape of a magnetic disk 16, and outer side wall 54c positioned on the opposite side of the inner side wall.

An inlet port 56 is formed in the bottom wall 54a of the casing 52. Inside the casing 52, a lower partition wall 60 is formed parallel to the bottom wall 54a with a gap held between them, and airway 61 is formed between the bottom wall and lower partition wall 60. Further, a vent hole 62 is formed in the lower partition wall 60 at a position separate from the exhaust port 57. The airway 61 communicates with the inlet port 56 and vent hole 62.

A relatively large top opening 67 is formed in the top wall of the casing 52, and at the time of assembly, adsorbent 80 such as activated charcoal or the like is filled into a reception chamber 79 of the casing 52 from the top opening 67. After filling of the adsorbent 80, the top opening 67 is closed with a cover film 86 having air permeability such as a membrane or the like. Further, an outer surface cover 90 having no air permeability such as PET is provided outside the cover film 86 and outer side wall 54c with a gap 88 held between the cover 90 and film 86 or wall 54c, thereby covering the cover film 86 and outer side wall 54c from outside. The gap 88 is opened to the outside at an outside part of a lower end part of the outer side wall 54c, thereby forming an exhaust port 57.

Further, the gap 88 is provided with a function of a pooling section configured to pool contaminant like a simplified labyrinthine structure, and reduces the possibility of the contaminant being transferred into the housing 10. Further, an adsorption layer 92 configured to adsorb the contaminant may be provided on the surface of the outer surface cover 90 on the cover film 86 side. In order to form the adsorption layer 92, when there is no problem such as outgassing or the like, the adhesive surface of the outer surface cover 90 constituted of a material having no air permeability configured to adhere the cover 90 to the casing 52 may only be opened, or a structure configured to adsorb contaminant such as a flow-by filter may be affixed to the surface.

FIG. 7 shows the structure before sticking the outer surface cover 90 to the casing. The outer circumferential part of the casing 52 is formed higher by an amount corresponding to the gap, and the outer surface cover 90 is affixed to the face of the edge. As a result of this, it is possible to prevent the manufacturing cost, to the utmost, from increasing without the need for making the shape of the casing 52 complicated.

The aspiration filter 50 configured as described above is provided on the aspiration hole 82 formed in the housing 10 as shown in FIG. 6. The bottom surface of the casing 52 is affixed to the bottom wall 12a of the base 12 by means of an adhesive layer 84 so that the aspiration filter 50 can cover the aspiration hole 82. At this time, the casing 52 is arranged in such a manner that the inlet port 56 of the bottom wall 54a is positioned in line with the aspiration hole 82 to communicate with the aspiration hole 82.

Further, the casing 52 is arranged in a state where the inner side wall 54b is opposed to the outer circumference of the magnetic disk 16 with a small gap held between them, and the outer side wall 54c is positioned on the opposite side of the magnetic disk 16. As a result of this, the exhaust port 57 formed at the outer side wall 54c is positioned on the opposite side of the magnetic disk 16, and is positioned separate from the magnetic disk. Further, the top wall of the casing 52 is opposed to the top cover 11 with a gap held between them.

In the aspiration filter 50, the outside air flowing into the aspiration filter 50 from the aspiration hole 82 through the inlet port 56 flows through the airway 61, and flows into a reception chamber 79 of the casing 52 from the vent hole 62. Further, the outside air passes through the adsorbent 80 such as the activated charcoal or the like contained in the reception chamber 79. At this time, the contaminant such as dust, moisture, gas components, and the like contained in the outside air is removed by the adsorbent 80. The outside air from which the contaminant has been removed passes through the top opening and cover film 86, then flows into the gap 88, i.e., the pooling section, further goes to the exhaust port 57, and is then discharged to the inside of the housing 10.

The outside air flowing into the casing 52 from the inlet port 56 is discharged from the exhaust port 57 after being sufficiently brought into contact with the adsorbent 80 such as the activated charcoal or the like without directly flowing into the exhaust port 57. Further, contaminant that has not been completely removed or a fragment of the activated charcoal or the like is pooled in the pooling section, and is captured by the adsorption layer 92 by adsorption. As a result of this, it is possible to largely reduce the amount of contaminant discharged from the aspiration filter 50 to the inside of the housing 10.

The exhaust port 57 of the casing 52 is provided at the outer side wall 54c positioned on the opposite side of the magnetic disk 16, and is positioned on the opposite side of the magnetic disk 16 separate from the magnetic disk. That is, the exhaust port 57 is provided at a position separate from an area in which the flow of air toward the center side of the magnetic disk 16 is generated. Accordingly, even when contaminant mixed with the outside air without being removed by the aspiration filter 50, or a fragment of the adsorbent is discharged to the inside of the housing 10 through the exhaust port 57, the contaminant, fragment or the like is not directly transferred onto the magnetic disk 16 by the flow of air toward the center side of the magnetic disk 16. As shown in FIG. 6, the contaminant, fragment or the like C stagnantly remains in the space between the aspiration filter 50 and sidewall 12b of the base 12, and is prevented from being transferred onto the surface of the magnetic disk 16.

From the above description, it is possible to obtain a high-reliability aspiration filter configured to reduce the risk of the air entering the magnetic disk device from outside through the aspiration filter being directly transferred onto the magnetic disk 16, and disk device provided with the aspiration filter.

In the second embodiment, the other configurations of the HDD are identical with the first embodiment described previously, further parts identical with the first embodiment are denoted by reference symbols identical with the first embodiment, and a detailed description of them is omitted. It should be noted that although the second embodiment described above is configured in such a manner that the aspiration hole 82 is provided in the base 12, and aspiration filter 50 is provided on the bottom wall of the base, the configuration is not limited to this, and the configuration in which the aspiration hole is formed in the top cover, and aspiration filter is arranged on the inner surface of the top cover may also be employed. In this case too, the exhaust port 57 of the casing 52 is provided on the opposite side of the magnetic disk 16. Further, the position of the aspiration filter 50 is not limited to the corner part in the housing 10, and the filter 50 may also be provided at the other position.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the material, shape, size, and the like of each element constituting the aspiration filter can be changed as the need arises. Further, in the magnetic disk device, the number of the magnetic disks or magnetic heads can be increased as the need arises, and size of the magnetic disk can also be variously selected.

1. A disk device comprising:
a housing configured to contain therein a disk-shaped recording medium;
a driver configured to rotate the recording medium;
a head configured to subject the recording medium to information processing; and
an aspiration filter in the housing, comprising a casing comprising an inner side portion facing the recording medium, and an outer side portion on the opposite side of the recording medium with respect to the inner side portion, and containing therein an adsorbent configured to adsorb a substance in air, an inlet port in the casing and configured to take outside air into the casing, and an exhaust port in the outer side portion and configured to discharge the outside air that has passed through the adsorbent to the inside of the disk device.

2. The disk device of claim 1, wherein the casing of the aspiration filter comprises an inner side wall facing the recording medium, an outer side wall comprising the exhaust port on the opposite side of the recording medium with respect to the inner side wall, and a bottom wall comprising the inlet port.

3. The disk device of claim 2, wherein the aspiration filter comprises a cover with air permeability, configured to cover the exhaust port.

4. The disk device of claim 1, wherein the casing of the aspiration filter comprises an exhaust side partition wall between the inlet port and the exhaust port.

5. The disk device of claim 2, wherein the casing of the aspiration filter comprises a top opening facing the bottom wall, a cover with air permeability, configured to cover the top opening, and an outer surface cover configured to cover the cover and the outer side wall with a gap, and to define the exhaust port at an end portion of the outer side wall.

6. The disk device of claim 5, wherein the casing of the aspiration filter comprises an adsorption layer facing the cover on an inner surface of the outer surface cover.

7. An aspiration filter used for a disk device comprising a disk-shaped recording medium, comprising:
a casing comprising an inner side portion facing the recording medium, and an outer side portion on the opposite side of the recording medium with respect to the inner side portion, and containing therein adsorbent configured to adsorb a substance in air;
an inlet port in the casing and configured to take outside air into the casing; and
an exhaust port in the outer side portion and configured to discharge the outside air that has passed through the adsorbent to the inside of the disk device.
